(19) United States
(12) Patent Application Publication
(10) Pub. No.: US 2021/0019801 A1
(43) Pub. Date: Jan. 21, 2021

(54) SYSTEMS AND METHODS FOR AUTOMATED FOOD INGREDIENT ANALYSIS

(71) Applicant: Walmart Apollo, LLC, Bentonville, AR (US)

(72) Inventors: Gregory D. Dixon, Rogers, AR (US); Ojaswini Chhabra, Bangalore (IN); Souradip Chakraborty, Bangalore (IN); Mallikharjuna M. Vallabhajosyula, Bangalore (IN)

(21) Appl. No.: 16/930,726

(22) Filed: Jul. 16, 2020

Related U.S. Application Data
(60) Provisional application No. 62/898,710, filed on Sep. 11, 2019.

(30) Foreign Application Priority Data
Jul. 16, 2019 (IN) 201941028525

(51) Int. Cl. G06Q 30/06; G09B 19/00

(52) U.S. Cl. CPC G06Q 30/0627; G09B 19/0092

(57) ABSTRACT

Systems, apparatuses, and methods are provided herein for automated food ingredient analysis. A method comprises retrieving a ingredients list associated with a food product, parsing the ingredients list to an ordered list of a plurality of ingredients, matching an ingredient of the plurality of ingredients to a reference ingredient to determine a nutrition content associated with the ingredient, assigning ingredient share ranking to the ingredient based on its position on the ingredients list, retrieving nutrition label information associated with the food product, and determining estimated ingredient shares of one or more of the plurality of ingredients in the food product based on the nutrition content of the one or more of the plurality of ingredients, the ingredient share ranking s of the one or more of the plurality of ingredients, and the overall nutrition content of the food product.

This application claims the benefit of U.S. Provisional Application No. 62/898,710, filed Sep. 11, 2019, which claims the benefit of Indian Provisional Application No. 201941028525, filed Jul. 16, 2019, both of which are incorporated herein by reference in their entireties.

### TECHNICAL FIELD

This invention relates generally to analysis of food ingredients.

### BACKGROUND

The United States Department of Agriculture (USDA) mandates that processed food items should include their nutritional information in a specific format as well as a list of all ingredients used to produce the product. However, manufacturers are generally not required to disclose the exact amount of each ingredient that goes into the production of a food product. Determining how much of each ingredient is in the food product through lab testing can be expensive and time-consuming.

### BRIEF DESCRIPTION OF THE DRAWINGS

Disclosed herein are embodiments of apparatuses and methods for automated food ingredient analysis. This description includes drawings, wherein:

FIG. 1 comprises a system diagram in accordance with several embodiments;

FIG. 2 comprises a flow diagram in accordance with several embodiments;

FIG. 3 comprises an example of a food label in accordance with several embodiments;

FIGS. 4A and 4B comprise examples of reference ingredients in accordance with several embodiments; and

FIGS. 5A and 5B comprise illustrations of an example result in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for automated food ingredient analysis. In some embodiments, a system for automated food ingredient analysis comprises a reference ingredients database storing nutrition content information associated with a plurality of reference ingredients, wherein nutrition content information comprises amounts of a plurality of nutrients in a set amount of a food item, a food products database storing ingredients lists and nutrition label information of food products, and a control circuit coupled to the reference ingredients database and the food products database. The control circuit is configured to retrieve a ingredients list associated with a food product from the food products database, parse the ingredients list to an ordered list of a plurality of ingredients, match an ingredient of the plurality of ingredients to a reference ingredient in the reference ingredients database to determine a nutrition content associated with the ingredient, and assign ingredient share ranking to the ingredient based on its position on the ingredients list. The control circuit further retrieves nutrition label information associated with the food product, which comprises an overall nutrition content of the food product. The control circuit then determines estimated ingredient shares of one or more of the plurality of ingredients in the food product based on the nutrition content of the one or more of the plurality of ingredients, the ingredient share rankings of the one or more of the plurality of ingredients, and the overall nutrition content of the food product.

The United States Department of Agriculture (USDA) mandates that processed food item should contain all its nutritional information in a specific format as well as the list of all ingredients used to produce it. This list of ingredients provides ingredients in descending order of their share. However, the disclosure of the exact share of the ingredients is not mandated and the exact amount of each ingredient that goes into the production of a particular food product that comprises more than one ingredient is difficult to determine. As food items become more processed and include more ingredients, the exact share of each ingredient used becomes even more difficult to determine.

Knowing the approximate ingredient share of food items can provide retailers significant negotiating power and save cost. For example, a retailer can better negotiate with a canned beef soup supplier if it knows the price of beef and exactly how much beef is present in one can of the soup. Ingredient share information can also be used in comparing different suppliers that charge different prices for similar kinds of products (e.g. two different brands/suppliers of beef soup).

In some embodiments, systems and methods described herein provide an algorithmic model that can calculate the ingredient shares of different packaged food items given its nutrient information label and the list of ingredients.

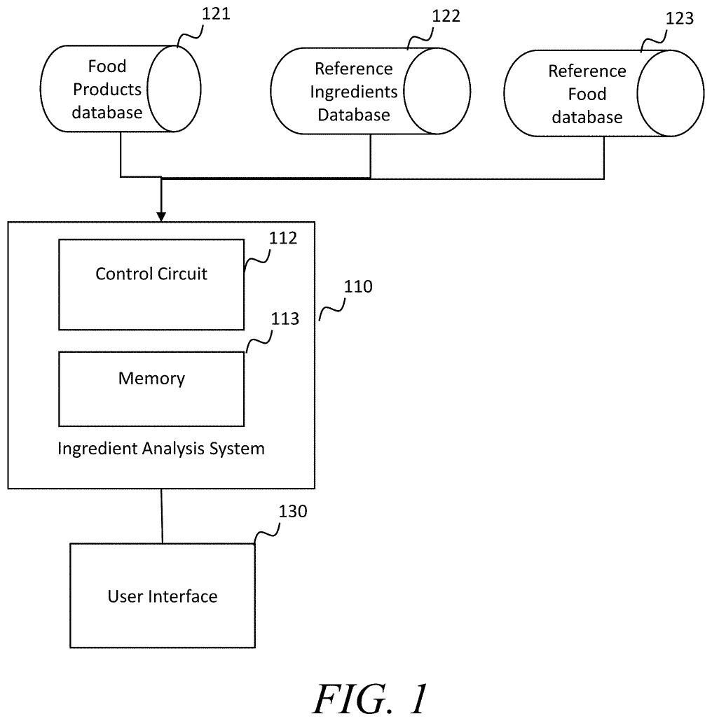

Referring now to FIG. 1, a system for analyzing food ingredients is shown. The system comprises an ingredient analysis system 110, a food products database 121, a reference ingredients database 122, a reference food database 123, and a user interface device 130. The ingredient analysis system 110 comprises a control circuit 112 and a memory 113.

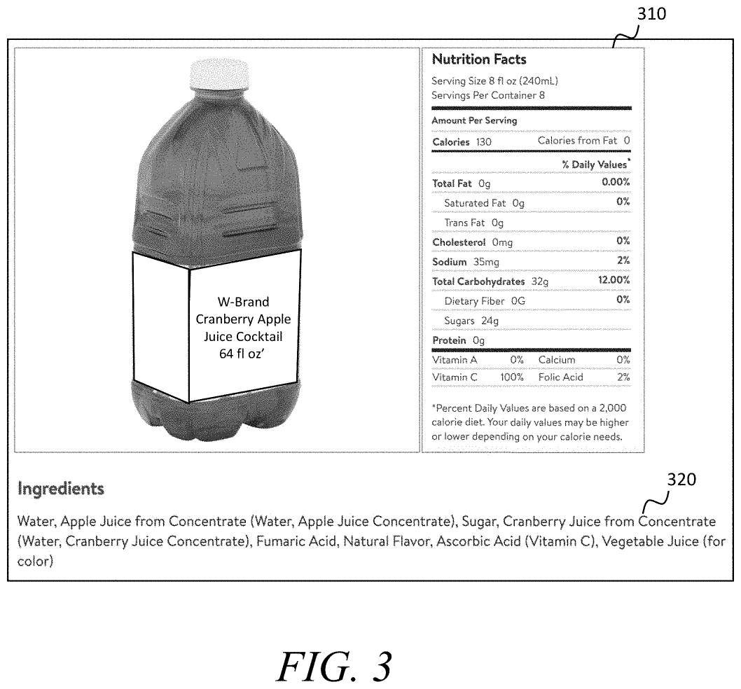

In some embodiments, the ingredient analysis system 110 may comprise a computer, a processor-based device, a server, a cloud-based server, a networked computer, etc. The control circuit of the ingredient analysis system 110 may comprise a processor, a microprocessor, a microcontroller, an application specific integrated circuit (ASIC) and the like and is configured to execute computer-readable instructions stored in computer-readable storage memory. The computer-readable storage memory may comprise volatile and/or non-volatile memory and have stored upon it a set of computer readable instructions which, when executed by the control circuit, causes the control circuit to communicate with one or more of the food products database 121, the reference ingredients database 122, the reference food database 123, and the user interface device 130 to estimate the ingredient shares of a food product. In some embodiments, the control circuit of the ingredient analysis system 110 may be configured to perform one or more steps described with reference to FIG. 3 herein. In some embodiments, the ingredient analysis system 110 may further comprise a network adapter configured to communicate with one or more of the food products database 121, the reference ingredients database 122, the reference food database 123, and the user interface device 130 over a network such as a private network, a local area network, and the Internet.

The food products database 121 generally refers to a computer readable memory device configured to store food product information. Food product information may comprise nutrition content information and ingredients list. Nutrition content information may include the total amount of one or more of the following in each serving: calories, calories from fat, fat, saturated fat, trans fat, cholesterol, sodium, carbohydrates, dietary fiber, sugars, and protein. In some embodiments, nutrition information may further include micronutrients such as vitamin A, vitamin C, calcium, iron, vitamin B6, Folate, Biotin, Vitamin D, Vitamin E Vitamin K, Phosphorus, Iodine, Magnesium, Zinc, etc. In some embodiments, nutrition content information may comprise information in a nutrition facts label or nutrition information panel. An example of a nutrition facts label 310 is shown in FIG. 3. In some embodiments, nutrition information may include the weight and/or the percentage daily value of each nutrient listed per serving. The ingredients list generally comprise a list of ingredients that are in descending order according to the amount of each ingredient that is present in the food product. An example of an ingredients list 320 is shown in FIG. 3. In some embodiments, food product information may include other ingredient threshold information such as “less than 2% sugar” and “12% fruit juice.” Ingredient share threshold information may be used as a constraint in the ingredient analysis. In some embodiments, food product information may be obtained via a label reader capturing images of the packaging of a food product. For example, a camera may be used to capture an image of the nutrition facts label, the ingredients list, and any other text on the packaging. The system may perform text recognition via an optical character reader (OCR) to parse nutrition information to store in the database. In some embodiments, food product information may be obtained from a public database or from the manufacturer or supplier. In some embodiments, the reference ingredients database 122 may comprise the USDA Food Composition Database, including the USDA Branded Food Products database and/or other similar databases.

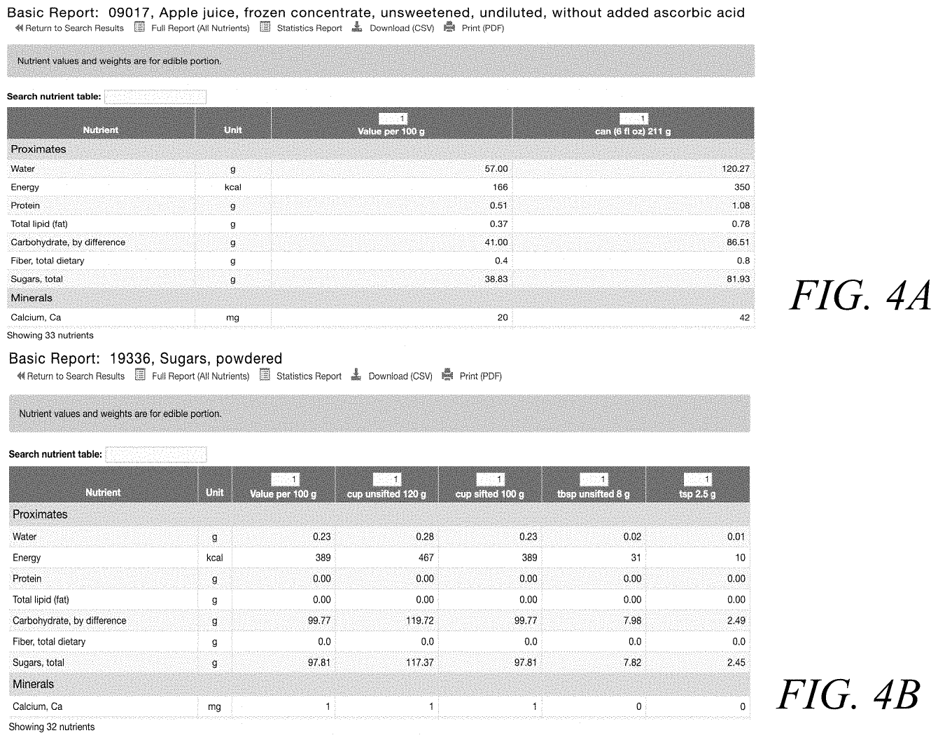

The reference ingredients database 122 generally refers to a computer readable memory device configured to store a plurality of reference ingredients and their respective nutrition content. In some embodiments, the reference ingredients database 122 may comprise a public and/or private database that aggregates nutrition information for individual ingredients. Nutrition information for individual ingredients may comprise calories, calories from fat, fat, saturated fat, trans fat, cholesterol, sodium, carbohydrates, dietary fiber, sugars, protein, and micronutrients. In some embodiments, the reference ingredients database 122 may comprise the USDA Food Composition Database, including the USDA National Nutrient Database for Standard Reference and/or other similar databases. Examples of nutrition content information of reference ingredients are shown in FIGS. 4A and 4B herein.

The Reference food database 123 generally refers to a computer readable memory device configured to store food ingredient share information of a plurality of food products. Ingredient share information of a food product generally refers to the amount of each ingredient (by weight or percentage) that is present in the food product. In some embodiments, the reference food database 123 may comprise records of food products with known ingredient shares. In some embodiments, the reference food database 123 may comprise records of food products previously analyzed and validated by the ingredient analysis system 110. In some embodiments, the reference food database 123 and the reference ingredients database 122 may overlap or may be implemented as a single database. For example, a reference food product (e.g. peanut butter) may be used to estimate the nutritional content of a nested ingredient on the ingredients list of another food product (e.g. peanut butter stuffed pretzels). In some embodiments, one or more of the food products database 121, the reference ingredients database 122, and the reference food database 123 may be implemented on the memory 113 of the ingredient analysis system 110.

The user interface device 130 may comprise one or more devices configured to allow human operators to interact with the ingredient analysis system 110. The user interface device 130 may comprise a processor-based device comprising at least a control circuit and a memory device. The control circuit of the user interface device 130 may comprise a processor, a microprocessor, a microcontroller, and the like and is configured to execute computer-readable instructions stored in a computer-readable storage memory. The computer-readable storage memory may comprise volatile and/or non-volatile memory and have stored upon it a set of computer readable instructions which, when executed by the control circuit, causes the control circuit to provide a user interface to interact with the ingredient analysis system 110. In some embodiments, the user interface device 130 may execute a computer program configured to provide one or more functions described herein. In some embodiments, the user interface device 130 may comprise one or more user input/output devices such as a display screen, a keyboard, a touch screen, a speaker, a microphone, an optical scanner, an RFID scanner, a camera, etc. In some embodiments, users may use the user interface device 130 to capture/enter product data into the food products database 121. For example, the user interface may comprise a camera for capturing images of a food product's label including nutrition facts label and ingredients list. In some embodiments, food product information may be supplied by manufacturers and/or suppliers or retrieved from a pre-populated database. In some embodiments, the user interface device 130 may be configured to display estimated food ingredient shares to users. In some embodiments, the user interface device 130 may communicate with the ingredient analysis system 110 via a wired connection, a wireless connection, a networked connection, a local area network, a private network, the Internet, etc. While only one user interface device 130 is shown, in some embodiments, the ingredient analysis system 110 may be configured to communicate with a plurality of user interface devices 130 and simultaneously support multiple instances of ingredient analysis through parallel processing. In some embodiments, the user interface device 130 may be integrated with the ingredient analysis system 110 as a single device or system.

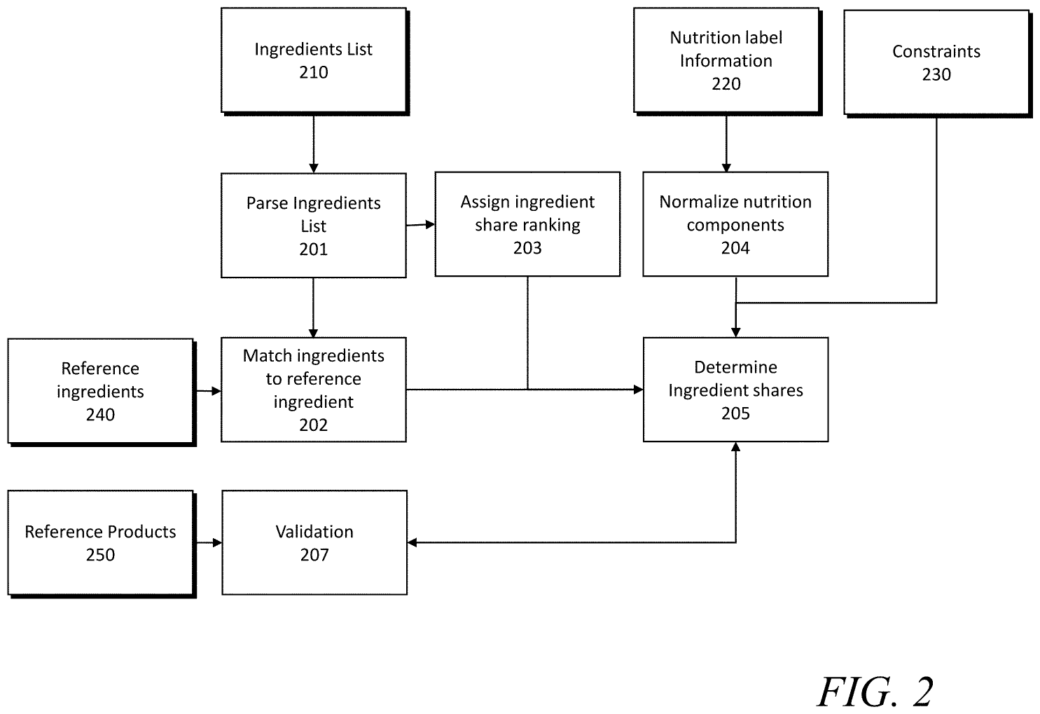

Referring now to FIG. 2, a method for automated ingredient analysis is shown. In some embodiments, the steps shown in FIG. 2 may be performed by a processor-based device such as one or more of a computer, a central computer system, a server, a cloud-based server, etc. In some embodiments, the steps in FIG. 2 may be performed by the ingredient analysis system described with reference to FIG. 1 herein or similar devices.

In step 201, the system retrieves and parses a ingredients list 210. The ingredients list 210 may comprise the listing of ingredients found on food packaging. In some embodiments, the ingredients list 210 may be retrieved from a public database, a private database, a manufacturer website, and/or scanned from food packaging. In some embodiments, parsing the ingredients list comprises identifying nested ingredients which includes a primary ingredient and a plurality of secondary ingredients on the ingredients list. In the ingredients list shown in FIG. 3 for example, “Apple Juice from Concentrate” is a nested ingredient in which “Apple Juice from Concentrate” is the primary ingredient and “water” and “apple juice concentrate” are secondary ingredients. Nested ingredients may be analyzed with the process described herein to determine the ingredient share of secondary ingredients in the primary ingredient. If any secondary ingredient includes further nested tertiary ingredients, the tertiary ingredients may also be analyzed with the processed described herein. The system may be configured to identify and process any level of nested ingredients (e.g. 4^{th}, 5^{th} levels).

In step 202, the ingredients in the ingredients list are each matched to a reference ingredient. In some embodiments, the reference ingredients may be stored in a reference ingredients database storing nutrition content information associated with a plurality of reference ingredients, wherein nutrition content information comprises amounts of a plurality of nutrients in a set amount of a food/ingredient. In some embodiments, matching a listed ingredient to a reference ingredient comprises natural language processing and approximate string matching. In some embodiments, ingredients with no nutrient content (e.g. water) and insignificant nutrient (e.g. pepper, cinnamon) may be omitted at this step.

In step 203, the parsed ingredients are each assigned an ingredient share ranking. Generally, ingredients are listed in descending order of amount on the ingredients list, and the rankings are assigned based on the positions of ingredients on the list. In some embodiments, if nested ingredients are present, a separate ranking may be assigned for secondary ingredients of a primary ingredient. As such, the same ingredient (e.g. sugar) may be ranked as a primary ingredient of the food product and also as a secondary ingredient to one or more other primary ingredients (e.g. sugar in tomato sauce). In the ingredients list shown in FIG. 3 for example, “water” appears as a primary ingredient, as a secondary ingredient to the primary ingredient of “Apple Juice from Concentrate”, and again, as a secondary ingredient to “Cranberry Juice from Concentrate.” The ingredient share ranking is used by the system to enforce a minimum and a maximum amount for each ingredient based on the ingredients that come before and after it.

In step 204, nutrition label information 220 of the food product is retrieved and normalized. In some embodiments, nutrition label information may comprise information in a nutrition facts label or nutrition information panel and comprises overall nutrition content of the food product. Nutrition label information is often provided in weight and/or percentage of daily value per serving. The system may first normalize the weight and/or percentage of each nutrient to a standardized weight (e.g. 100 g) to match the scale of the reference ingredients 240.

In step 205, the system determines estimated ingredient shares of one or more of the plurality of ingredients in the food product based on the nutrition content of the one or more of the plurality of ingredients, the ingredient share rankings of the one or more of the plurality of ingredients, and the overall nutrition content of the food product. In some embodiments, the determination is further based on applying constraints 230. Domain-specific constraints may comprise conservation of mass, such that the sum of the proportion of ingredients should be less than or equal to one. For example, the total of all ingredients in 100 g of an item should be 100 g or that sum of all percentage share in an item should be 100%. Another constraint may comprise ensuring that the ingredient share of each ingredient follows their ingredient share ranking as determined in step 203. In some embodiments, if a least one ingredient has a known threshold value (e.g. “less than 5% sugar”), the known threshold value may be applied as another constraint.

In some embodiments, the estimated ingredient shares of the one or more of the plurality of ingredients are determined using a 1-layer artificial neural network model. In the neural network, each nutritional component is used as a training sample (X, y) such that the number of training samples to estimate the ingredient share of an item is equal to the number of nutritional components considered (e.g. energy, protein, total fat, fiber, sugar, sodium, cholesterol, saturated fat etc.). All the nutritional components that are present in the food item (non-zero) may be considered in the model.

For the training sample (X, y) of a nutritional component, y corresponds to the amount of that nutritional component in a set amount (e.g. 100 g) of that food item and X corresponds to a row vector containing the amount of that nutritional component in each of the ingredients in the food item.

As an example, to estimate the share of the ingredients in ‘W-Brand Cranberry Apple Juice Cocktail, 64 fl oz’ shown in FIG. 3, the (X,y) observation pair corresponding to the nutrient ‘carbohydrate’ may be as follows:

y: Amount of carbohydrate in 100 g of the juice, i.e., y_{carbohydrate}=13.75
X: Row vector containing the amount of carbohydrate in all the ingredients that are used in juice, i.e., X_{carbohyrdate}=X_{carbohydrate,apple juice}, x_{carbohydrate, sugar}, x_{carbohydrate, cranberry juice}, x_{carbohydrate, vegetable juice})=(41, 99.77, 51.45, . . . , 3.87)

In some embodiments, a one-layer Artificial Neural Network model with gradient descent with multiple epochs is used to iteratively come up with the appropriate proportion of the ingredients corresponding to each item. This is similar to creating a system of linear equations with constraints and solving to get the closest estimates. For a food item with ‘n’ ingredients, the corresponding amounts (in grams) for the ingredients are (p1, p2, p3 . . . pₙ) where pᵢ is the amount of the i^{th} ingredient. P is the vector representing the same in Rⁿ (n^{th} dimensional space).

Ingredients to nutrients are mapped in which nutrients applicable from nutrition label are considered. In the corresponding matrix shown below, ‘k’ represents nutrients being considered and xij represent the amount corresponding to the i^{th} nutrient and j^{th} ingredient.

| | Ingredient1 | Ingredient2 | Ingredient3 | Ingredient4 . . . |
|---|---|---|---|---|
| Nutrient1 | x11 | x12 | x13 | x14 |
| Nutrient2 | x21 | x22 | x23 | x24 |
| Nutrient 3 | x31 | x32 | x33 | x34 . . . |
| . . . | . . . | . . . | . . . | . . . |

The above matrix (M) represents the nutrient to ingredient mapping and the order of the matrix is (k*n), where k is the number of nutrients and n is the number of ingredients. In this example, the total amount of nutrients presents in the item of consideration have been taken from the USDA document. For the item of consideration, Y is a vector representing the amount each of the k nutrients present in the item, which is in R^{k} (y1, y2, y3 . . . yk.) The system of equation from the above equation is stated below.

$${M}_{( k * n )} * {P}_{( n * 1 )} = {Y}_{( k * 1 )} \\ [ \begin{matrix}x 11 & x 12 & x 13 & … & x 1 n \\ x 21 & x 22 & x 23 & … & x 2 n \\ x 31 & x 32 & x 33 & … & x 3 n \\ … & … & … & … & … \\ … & … & … & … & … \\ xk 1 & xk 2 & xk 3 & … & xkn\end{matrix} ] * \vert \begin{matrix}p 1 \\ p 2 \\ p 3 \\ … \\ … \\ pn\end{matrix} \vert = \vert \begin{matrix}y 1 \\ y 2 \\ y 3 \\ … \\ … \\ yk\end{matrix} \vert$$

Subject to the constraints,
Σpᵢ=1, i.e., the sum of amounts/proportion of items present should be equals to 1.
p(1)>p(2)>p(3) . . . >p(n), i.e., the order of the ingredients should be maintained.
Σpₙ₋ₖ<threshold, i.e., the amount for ingredients lower down the order is present beyond a threshold.

A single layer neural network with gradient descent algorithm is used to iteratively estimate the correct value of the amounts of the ingredients (p1, p2, p3 . . . pₙ)

Loss=Σᵢ₌₁^{k}(yᵢ−ŷᵢ)\hat{ }2+λ(Σⱼ₌₁ⁿ(pⱼ)−1)\hat{ }μ

where,
yᵢ—amount of the i^{th} nutrient present in the item.
ŷᵢ—predicted amount of the i^{th} nutrient.
pᵢ—amount of the j^{th} ingredient present in the item. (to be estimated)
λ,μ—model hyperparameters.

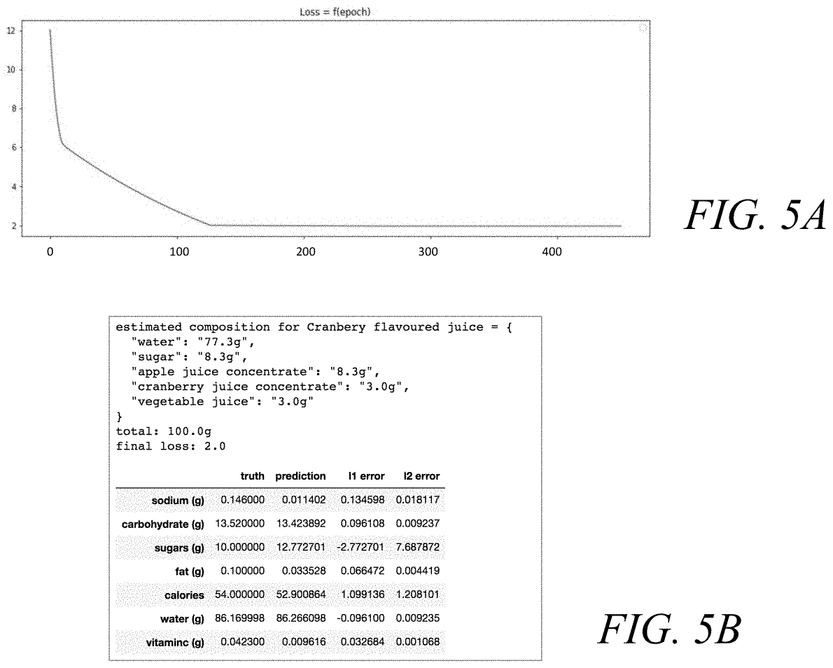

The results for ‘W-Brand Cranberry Apple Juice Cocktail, 64 fl oz’ are shown in FIG. 5A which shows a plot of loss with the number of iterations and FIG. 5B which shows the final estimate of share obtained from the model. As seen from the plot, with a greater number of iterations the loss converges. In some embodiments, the parameters the stop threshold of the iterations may be configurable to balance between processing time and accuracy.

In some embodiments, secondary and any tertiary ingredients may be included in the analysis in which constraints include the share ranking of each secondary/tertiary ingredient within the primary ingredient conforms to their ordering within the primary ingredient and that the total weight of secondary ingredients conforms to the ingredient share ranking of the primary ingredient within the ingredients list of the food product. In some embodiments, the system may similarly match a secondary ingredient of the plurality of secondary ingredients to a reference ingredient in the reference ingredients database to determine a nutrition content of the secondary ingredient, determine estimated ingredient shares of one or more secondary ingredients in the primary ingredient, and determine the nutrition content of the primary ingredient based on the nutrition contents and the estimated ingredient shares of the one or more secondary ingredients.

In some embodiments, the process may determine ingredient share of ingredients with no or insignificant nutrition content based on defining a composition share range for the ingredient with no or insignificant nutrition content based on composition share rankings of the plurality of ingredients in the food product. For example, the amount of water in a food product may be determined based on the relative ranking of water on the ingredients list (e.g. below sugar, above apple puree). In some embodiments, the process may determine ingredient shares of two or more ingredients having similar nutrition contents based on defining composition share ranges for each of the two or more ingredients having similar nutrition contents based on the composition share rankings associated with the plurality of ingredients in the food product. For example, sugar and high glucose corn syrup may have similar nutrition content and their respective shares may be determined based on their position on the ingredients list. Generally, each ingredient's share is capped by the share of the ingredient above it on the ingredients list.

While one-layer neural network is described in the example above, other methods and algorithms may be used for automated ingredient analysis. In some embodiments, other types of neural network such as multilayer perceptron neural network and recurrent neural network may be used. In some embodiments, exponential smoothing and/or a basic inference model may be used in step 205. In some embodiments, step 205 may be based on linear programming and simplex wherein percentage share of the constituting ingredients in processed food items are optimized and estimated based on constraints. In some embodiments, step 205, may be based on quadratic programming and convex optimization, which allows the objective function to have quadratic terms, while the set of constraints are specified with linear equalities and inequalities.

In step 207, the system performs model validation on the results from step 205. In some embodiments, validation may be performed based on anomaly detection. The system may select one or more reference food products 250 from a reference food database with previously or concurrently determined ingredient shares to perform anomaly detection. For example, food products in different sizes (e.g. full size vs. fun size candy bar) may be compared for validation. Another example, similar food products (e.g. store brand vs name brand) may be selected for validation.

In some embodiments, the system may batch process a plurality of food items based on the steps described with reference to FIG. 2 in parallel. In some embodiments, analyzed products may be stored as reference food products 250 and/or a reference ingredient 240 for subsequent determinations.

In some embodiments, a system for automated food ingredient analysis comprises a reference ingredients database storing nutrition content information associated with a plurality of reference ingredients, wherein nutrition content information comprises amounts of a plurality of nutrients in a set amount of a food item, a food products database storing ingredients lists and nutrition label information of food products, and a control circuit coupled to the reference ingredients database and the food products database. the control circuit being configured to retrieve a ingredients list associated with a food product from the food products database, parse the ingredients list to an ordered list of a plurality of ingredients, match an ingredient of the plurality of ingredients to a reference ingredient in the reference ingredients database to determine a nutrition content associated with the ingredient, assign ingredient share ranking to the ingredient based on its position on the ingredients list, retrieve nutrition label information associated with the food product, the nutrition label information comprises an overall nutrition content of the food product, and determine estimated ingredient shares of one or more of the plurality of ingredients in the food product based on the nutrition content of the one or more of the plurality of ingredients, the ingredient share ranking s of the one or more of the plurality of ingredients, and the overall nutrition content of the food product.

In one embodiment, a method for automated food ingredient analysis comprises retrieving a ingredients list associated with a food product from a food products database storing ingredients lists and nutrition label information of food products, parsing, with a control circuit, the ingredients list to an ordered list of a plurality of ingredients, matching, with the control circuit, an ingredient of the plurality of ingredients to a reference ingredient in a reference ingredients database to determine a nutrition content associated with the ingredient, the reference ingredients database storing nutrition content associated with a plurality of reference ingredients, wherein nutrition content comprises amounts of a plurality of nutrients in a set amount of a food item, assigning ingredient share ranking to the ingredient based on its position on the ingredients list, retrieving nutrition label information associated with the food product, the nutrition label information comprises an overall nutrition content of the food product, and determining, with the control circuit, estimated ingredient shares of one or more of the plurality of ingredients in the food product based on the nutrition content of the one or more of the plurality of ingredients, the ingredient share ranking s of the one or more of the plurality of ingredients, and the overall nutrition content of the food product.

In one embodiment, an apparatus for automated food ingredient analysis, the apparatus comprising: a non-transitory storage medium storing a set of computer readable instructions and a control circuit configured to execute the set of computer readable instructions which causes to the control circuit to: retrieve a ingredients list associated with a food product from a food products database storing ingredients lists and nutrition label information of food products, parse, with the control circuit, the ingredients list to an ordered list of a plurality of ingredients, match, with the control circuit, an ingredient of the plurality of ingredients to a reference ingredient in a reference ingredients database to determine a nutrition content associated with the ingredient, the reference ingredients database storing nutrition content associated with a plurality of reference ingredients, wherein nutrition content comprises amounts of a plurality of nutrients in a set amount of a food item, assign ingredient share ranking to the ingredient based on its position on the ingredients list, retrieve nutrition label information associated with the food product, the nutrition label information comprises an overall nutrition content of the food product, and determine, with the control circuit, estimated ingredient shares of one or more of the plurality of ingredients in the food product based on the nutrition content of the one or more of the plurality of ingredients, the ingredient share ranking of the one or more of the plurality of ingredients, and the overall nutrition content of the food product.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for automated food ingredient analysis, the system comprising:
a reference ingredients database storing nutrition content information associated with a plurality of reference ingredients, wherein nutrition content information comprises amounts of a plurality of nutrients in a set amount of a food item;
a food products database storing ingredients lists and nutrition label information of food products; and
a control circuit coupled to the reference ingredients database and the food products database, the control circuit being configured to:
retrieve a ingredients list associated with a food product from the food products database;
parse the ingredients list to an ordered list of a plurality of ingredients;
match an ingredient of the plurality of ingredients to a reference ingredient in the reference ingredients database to determine a nutrition content associated with the ingredient;
assign ingredient share ranking to the ingredient based on its position on the ingredients list;
retrieve nutrition label information associated with the food product, the nutrition label information comprises an overall nutrition content of the food product; and
determine estimated ingredient shares of one or more of the plurality of ingredients in the food product based on the nutrition content of the one or more of the plurality of ingredients, the ingredient share ranking s of the one or more of the plurality of ingredients, and the overall nutrition content of the food product.

2. The system of claim 1, wherein parsing the ingredients list comprises identifying a primary ingredient having one or more levels of ingredients nested within the primary ingredient.

3. The system of claim 2, wherein the control circuit is further configured to:
match a secondary ingredient of the primary ingredient to a reference ingredient in the reference ingredients database to determine a nutrition content of the secondary ingredient;
determine estimated ingredient shares of one or more secondary ingredients in the primary ingredient; and
determine the nutrition content of the primary ingredient based on the nutrition contents and the estimated ingredient shares of the one or more secondary ingredients.

4. The system of claim 1, wherein the estimated ingredient shares of the one or more of the plurality of ingredients are determined using a 1-layer artificial neural network model.

5. The system of claim 4, wherein the 1-layer artificial neural network model is trained with training samples (X, y) wherein y corresponds to an amount of a nutrient per a set amount of the food product retrieved from the nutrition label, and X corresponds to an amount of the nutrient per in each ingredient of the food product determined based on the reference ingredients database.

6. The system of claim 1, wherein matching the ingredient to a reference ingredient comprises natural language processing and approximate string matching.

7. The system of claim 1, wherein ingredient share of an ingredient with no or insignificant nutrition content is determined based on defining an ingredient share range for the ingredient with no or insignificant nutrition content based on ingredient share ranking s of the plurality of ingredients in the food product.

8. The system of claim 1, wherein ingredient shares of two or more ingredients having similar nutrition contents are determined based on defining ingredient share ranges for each of the two or more ingredients having similar nutrition contents based on the ingredient share ranking s associated with the plurality of ingredients in the food product.

9. The system of claim 1, wherein the control circuit is further configured to: retrieve a known threshold value associated with at least one of the plurality of ingredients, and the estimated ingredient shares of the one or more of the plurality of ingredients are further determined based on the known threshold value associated with at least one of the plurality of ingredients.

10. The system of claim 1, wherein the control circuit is further configured to validate the estimated ingredient shares based on:
selecting, from a reference food database, one or more reference food products; and
performing anomaly detection using the estimated ingredient shares of the food product and stored ingredient shares of the one or more reference food products.

11. A method for rule-automated food ingredient analysis, the method comprising:
retrieving a ingredients list associated with a food product from a food products database storing ingredients lists and nutrition label information of food products;
parsing, with a control circuit, the ingredients list to an ordered list of a plurality of ingredients;
matching, with the control circuit, an ingredient of the plurality of ingredients to a reference ingredient in a reference ingredients database to determine a nutrition content associated with the ingredient, the reference ingredients database storing nutrition content associated with a plurality of reference ingredients, wherein nutrition content comprises amounts of a plurality of nutrients in a set amount of a food item;
assigning ingredient share ranking to the ingredient based on its position on the ingredients list;
retrieving nutrition label information associated with the food product, the nutrition label information comprises an overall nutrition content of the food product; and
determining, with the control circuit, estimated ingredient shares of one or more of the plurality of ingredients in the food product based on the nutrition content of the one or more of the plurality of ingredients, the ingredient share ranking s of the one or more of the plurality of ingredients, and the overall nutrition content of the food product.

12. The method of claim 11, wherein parsing the ingredients list comprises identifying a primary ingredient having one or more levels of ingredients nested within the primary ingredient.

13. The method of claim 12, further comprising:
matching a secondary ingredient of the primary ingredient to a reference ingredient in the reference ingredients database to determine a nutrition content of the secondary ingredient;
determining estimated ingredient shares of one or more secondary ingredients in the primary ingredient; and
determining the nutrition content of the primary ingredient based on the nutrition contents and the estimated ingredient shares of the one or more secondary ingredients.

14. The method of claim 11, wherein the estimated ingredient shares of the one or more of the plurality of ingredients are determined using a 1-layer artificial neural network model.

15. The method of claim 14, wherein the 1-layer artificial neural network model is trained with training samples (X, y) wherein y corresponds to an overall amount of a nutrient per a set amount of the food product retrieved from the nutrition label, and X corresponds to an amount of the nutrient per in each ingredient of the food product determined based on the reference ingredients database.

16. The method of claim 11, wherein matching the ingredient to a reference ingredient comprises natural language processing and approximate string matching.

17. The method of claim 11, wherein ingredient share of an ingredient with no or insignificant nutrition content is determined based on defining an ingredient share range for the ingredient with no or insignificant nutrition content based on ingredient share ranking s of the plurality of ingredients in the food product.

18. The method of claim 11, wherein ingredient shares of two or more ingredients having similar nutrition contents are determined based on defining ingredient share ranges for each of the two or more ingredients having similar nutrition contents based on the ingredient share ranking s associated with the plurality of ingredients in the food product.

19. The method of claim 11, further comprising:
retrieving a known threshold value associated with at least one of the plurality of ingredients, and the estimated ingredient shares of the one or more of the plurality of ingredients are further determined based on the known threshold value associated with at least one of the plurality of ingredients.

20. An apparatus for automated food ingredient analysis, the apparatus comprising: a non-transitory storage medium storing a set of computer readable instructions; and
a control circuit configured to execute the set of computer readable instructions which causes to the control circuit to:
retrieve a ingredients list associated with a food product from a food products database storing ingredients lists and nutrition label information of food products;
parse, with the control circuit, the ingredients list to an ordered list of a plurality of ingredients;
match, with the control circuit, an ingredient of the plurality of ingredients to a reference ingredient in a reference ingredients database to determine a nutrition content associated with the ingredient, the reference ingredients database storing nutrition content associated with a plurality of reference ingredients, wherein nutrition content comprises amounts of a plurality of nutrients in a set amount of a food item;
assign ingredient share ranking to the ingredient based on its position on the ingredients list;
retrieve nutrition label information associated with the food product, the nutrition label information comprises an overall nutrition content of the food product; and
determine, with the control circuit, estimated ingredient shares of one or more of the plurality of ingredients in the food product based on the nutrition content of the one or more of the plurality of ingredients, the ingredient share ranking of the one or more of the plurality of ingredients, and the overall nutrition content of the food product.
